(19) United States
(12) Patent Application Publication
(10) Pub. No.: US 2020/0140011 A1
(43) Pub. Date: May 7, 2020

(54) PARKING ASSISTANCE APPARATUS

(71) Applicant: AISIN SEIKI KABUSHIKI KAISHA, Kariya-shi, Aichi (JP)

(72) Inventors: Hironori HIRATA, Anjo-shi, Aichi-ken (JP); Nozomu MAEDA, Kariya-shi, Aichi-ken (JP)

(73) Assignee: AISIN SEIKI KABUSHIKI KAISHA, Kariya-shi, Aichi (JP)

(21) Appl. No.: 16/607,961

(22) PCT Filed: Mar. 6, 2018
(86) PCT No.: PCT/JP2018/008491

§ 371 Date: Oct. 24, 2019

(30) Foreign Application Priority Data
Apr. 27, 2017 (JP) 2017-088829

(51) Int. Cl. B62D 15/02; B62D 6/00; B62D 6/02

(52) U.S. Cl. CPC B62D 15/027; B62D 6/02; B62D 6/002; B62D 15/021

(57) ABSTRACT

The parking assistance apparatus of an embodiment includes: a memory; and a hardware processor coupled to the memory and configured to acquire a movement route to a target position when a steering angle of a vehicle is a given steering angle. The memory stores, with respect to individual steering angles other than the given steering angle, information representing a route where the vehicle is movable to a position included in the movement route by performing steering angle control beginning at the corresponding steering angle. The hardware processor acquires a steering angle of the vehicle, and calculates, based on the acquired steering angle, a corrected movement route to the target position by correcting the movement route with a route where the vehicle is movable to a position included in the movement route at the acquired steering angle in accordance with information representing the route stored in the memory.

### TECHNICAL FIELD

Embodiments according to the present invention relate to a parking assistance apparatus.

### BACKGROUND ART

Conventionally, in order to park a vehicle within a parking area, a technique has been proposed, which is for calculating a movement route from the current vehicle position to a parking position included in the parking area and controlling the vehicle to move along the movement route.

### CITATION LIST

### Patent Literature

Patent Literature 1: JP 2010-269707 A

Patent Literature 2: JP 2004-203315 A

### SUMMARY OF INVENTION

### Problems to be Solved by the Invention

In the conventional art, however, parking assistance is started when the steering angle is within a predetermined angle after the vehicle stops once. Thus, there is a restriction on the steering angle at the start of parking assistance.

An object of this invention is to provide a parking assistance apparatus which reduces the restriction on the steering angle of the vehicle at the time of starting parking assistance and implements more flexible parking assistance.

### Means for Solving Problem

A parking assistance apparatus according to an embodiment includes, for example: a route acquisition unit configured to acquire a movement route from an initial position of a vehicle to a target position when a steering angle of the vehicle is a given steering angle; a correction route storage unit configured to store, with respect to individual steering angles other than the given steering angle, information representing a route where the vehicle is movable from the initial position of the vehicle to a position included in the movement route by performing steering angle control beginning at the corresponding steering angle; an acquisition unit configured to acquire a steering angle of the vehicle; and a route correction unit configured to calculate, based on the steering angle acquired by the acquisition unit, a corrected movement route from the initial position to the target position of the vehicle by correcting the movement route with a route where the vehicle is movable to a position included in the movement route at the acquired steering angle in accordance with information representing the route stored in the correction route storage unit. According to this configuration, it is possible to reduce the restriction on the steering angle of the vehicle when starting control for moving the vehicle to the target position.

The parking assistance apparatus according to an embodiment further includes, for example, a circumference information storage unit configured to store information that represents a plurality of circumferences functioning as part of the movement route of the vehicle, wherein the route acquisition unit selects one of the plurality of circumferences stored in the circumference information storage unit, the selected one being a circumference that passes through the initial position and is tangential to a straight line extending in a traveling direction of the vehicle, and acquires the movement route where the selected circumference functions as part of the movement route, the correction route storage unit stores, in association with each of the plurality of circumference, information representing a route where the vehicle is movable from the initial position of the vehicle to a position included in the movement route by performing steering angle control beginning at the corresponding steering angle, and the route correction unit corrects the movement route with a route where the vehicle is movable to a position included in the movement route at the acquired steering angle in accordance with information representing the route stored in the correction route storage unit, the route being associated with the circumference used for calculating the movement route by the route acquisition unit. According to this configuration, for example, by correcting the movement route according to the circumference used for acquiring the movement route of the vehicle, it is possible to realize the correction of the movement route based on the movement destination and the steering angle of the vehicle.

In the parking assistance apparatus according to an embodiment, when the steering angle acquired by the acquisition unit is between a first steering angle and a second steering angle stored in the correction route storage unit, the route correction unit corrects the movement route with a route where the vehicle is movable to a position included in the movement route at the acquired steering angle in accordance with information representing the route stored in the correction route storage unit based on a steering angle having a larger absolute value between the first steering angle and the second steering angle. According to this configuration, for example, it is possible to guide the vehicle to the target position along the movement route according to the steering angle.

In the parking assistance apparatus according to an embodiment, the route correction unit does not perform the correction of the movement route when a speed of the vehicle is equal to or less than a second speed, and the parking assistance apparatus further comprises a steering angle controller configured to perform, when the speed of the vehicle is equal to or less than the second speed, steering angle control based on the movement route acquired by the route acquisition unit after performing control to make a steering angle of the vehicle the given steering angle. According to this configuration, for example, when the speed of the vehicle is equal to or less than the second speed, it is not necessary to correct the movement route. Thus, the processing burden can be reduced.

In the parking assistance apparatus according to an embodiment, the route correction unit corrects, based on the steering angle acquired by the acquisition unit, the movement route with a route where the vehicle is movable to a position included in the movement route at the acquired steering angle in accordance with information representing the route stored in the storage unit only when the vehicle speed is within a predetermined speed range. According to this configuration, for example, control for moving the vehicle to the target position can be started even when the vehicle is moving. Thus, convenience can be improved.

### BRIEF DESCRIPTION OF DRAWINGS

FIG. 1 is a perspective view illustrating a state in which part of a passenger compartment of a vehicle on which a parking assistance apparatus is mounted according to the present embodiment is seen through;

FIG. 2 is a plan view (overhead view) illustrating an example of a vehicle on which a parking assistance apparatus is mounted according to the present embodiment;

FIG. 3 is a block diagram illustrating a configuration of a control system including a parking assistance apparatus according to the present embodiment;

FIG. 4 is a block diagram illustrating a configuration of a control unit realized in the CPU of the parking assistance apparatus according to the present embodiment;

FIG. 5 is a diagram illustrating a table structure of a correction route storage unit according to the present embodiment;

FIG. 6 is a diagram illustrating a relationship between a capture timing of a captured image acquisition unit in a vehicle moving at a low speed, a moving distance of the vehicle, and a use period of the captured image that has been captured;

FIG. 7 is a diagram illustrating a relationship between a white line, a parking target position, a parking frame, and a vehicle according to the present embodiment in overhead view;

FIG. 8 is a schematic diagram illustrating an example of a correction calculation of a parking target position according to the present embodiment;

FIG. 9 is a diagram illustrating a movement route generation method by a route acquisition unit of the present embodiment;

FIG. 10 is a diagram illustrating a movement route acquired by the route acquisition unit of the present embodiment;

FIG. 11 is a diagram illustrating correction route information for each steering angle, which is stored in the correction route storage unit according to the present embodiment and associated with a turning radius R4 of the circumference;

FIG. 12 is a flowchart illustrating a procedure of parking target position recognition processing (coordinate correction process) according to the present embodiment;

FIG. 13 is a flowchart illustrating a procedure of parking assistance control processing according to the present embodiment; and

FIG. 14 is an explanatory diagram illustrating that a period during which the parking assistance can be executed is wider than that of a conventional system when the parking assistance apparatus according to the present embodiment is used.

### DESCRIPTION OF EMBODIMENTS

Hereinafter, exemplary embodiments of the present invention are disclosed. The configurations of the embodiments shown below, and the actions, results, and effects provided by the configurations are examples. The present invention can be realized by a configuration other than the configurations disclosed in the following embodiments, and it is possible to obtain at least one of various effects based on the basic configuration and derivative effects.

An example in which the parking assistance apparatus of the present embodiment is mounted on a vehicle 1 will be described. In the present embodiment, the vehicle 1 may be, for example, an automobile (an internal combustion engine automobile) that uses an internal combustion engine (an engine, not illustrated) as a drive source, an automobile (an electric vehicle, a fuel cell vehicle, etc.) using an electric motor (a motor, not illustrated) as a drive source, or an automobile (a hybrid automobile) that uses both of them as drive sources. Further, the vehicle 1 can include various transmissions, and various devices (systems, components, etc.) necessary for driving the internal combustion engine and the electric motor. In addition, the method, the number, the layout, and the like of devices related to driving of wheels 3 in the vehicle 1 can be set in various ways.

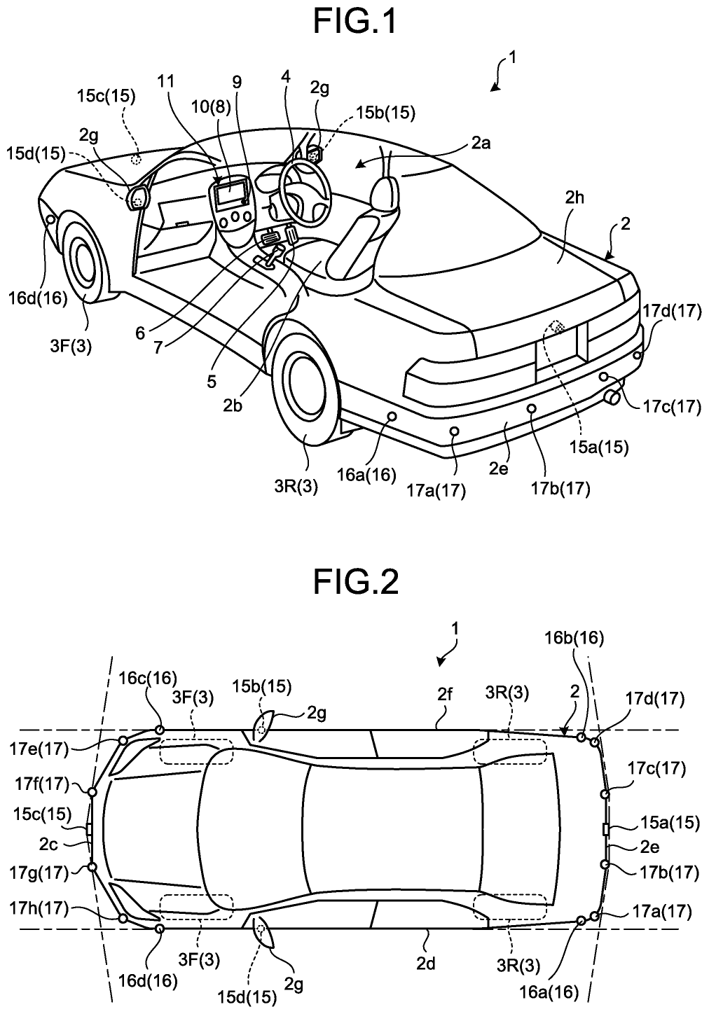

As illustrated in FIG. 1, a vehicle body 2 constitutes a passenger compartment 2a in which an occupant (not illustrated) rides. In the passenger compartment 2a, a steering unit 4, an acceleration operation unit 5, a braking operation unit 6, a shift operation unit 7, and the like are provided in a state of facing a seat 2b of the driver as an occupant. In the present embodiment, as an example, the steering unit 4 is a steering wheel protruding from a dashboard (instrument panel). The acceleration operation unit 5 is an accelerator pedal positioned under the driver's feet. The braking operation unit 6 is a brake pedal positioned under the driver's feet. The shift operation unit 7 is a shift lever protruding from the center console. However, the steering unit 4, the acceleration operation unit 5, the braking operation unit 6, and the shift operation unit 7 are not limited to thereto.

In the passenger compartment 2a, a display device 8 as a display output unit and a sound output device 9 as a sound output unit are provided. The display device 8 is, for example, a liquid crystal display (LCD), an organic electroluminescent display (OELD), or the like. The sound output device 9 is a speaker as an example. In the present embodiment, as an example, the display device 8 is covered with a transparent operation input unit 10 (for example, a touch panel). An occupant or the like can visually recognize a video (image) displayed on the display screen of the display device 8 via the operation input unit 10. An occupant or the like performs an operation input (an instruction input) by touching, pushing, or moving the operation input unit 10 with a finger or the like at a position corresponding to a video (an image) displayed on the display screen of the display device 8. In the present embodiment, as an example, the display device 8, the sound output device 9, the operation input unit 10, and the like are provided in a monitor device 11 that is located at the center of the dashboard in the vehicle width direction (a left-right direction). The monitor device 11 can have an operation input unit (not illustrated) such as a switch, a dial, a joystick, and a push button. Further, a sound output device (not illustrated) can be provided at another position in the passenger compartment 2a different from that of the monitor device 11. Also, sound can be output from the sound output device 9 of the monitor device 11 and another sound output device. In the present embodiment, as an example, the monitor device 11 is also used as a navigation system and an audio system. However the monitor device for the parking assistance apparatus may be provided separately from these systems.

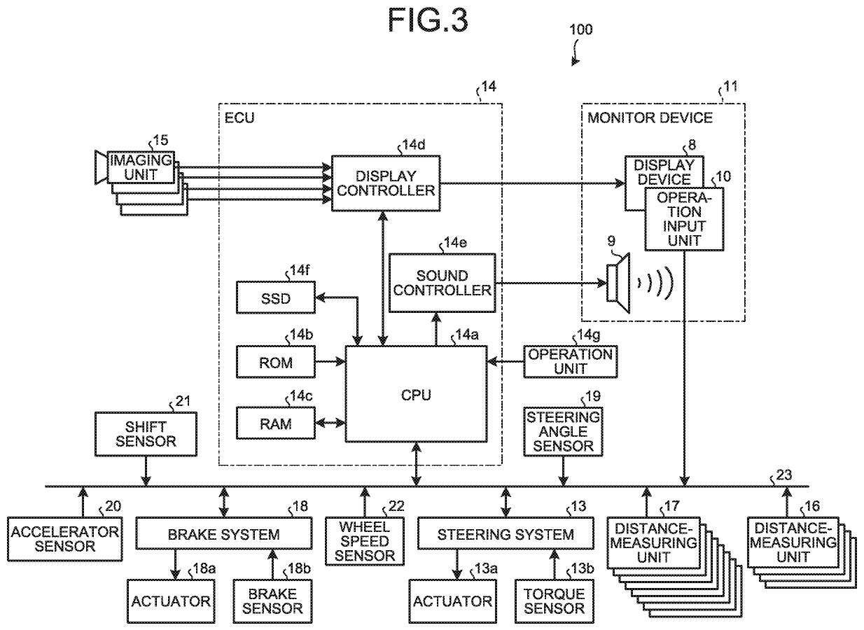

Also, as illustrated in FIGS. 1 and 2, in the present embodiment, as an example, the vehicle 1 is a four-wheeled vehicle (a four-wheeled automobile), and includes two left and right front wheels 3F and two left and right rear wheels 3R. In the present embodiment, these four wheels 3 may be configured to be steerable (configured that they can be steered). In the present embodiment, as illustrated in FIG. 3, the vehicle 1 has a steering system 13 for steering the front wheels 3F. The steering system 13 is electrically controlled by an electronic control unit (ECU) 14 or the like to operate an actuator 13a. The steering system 13 is, for example, an electric power steering system, a steer by wire (SBW) system, or the like. The steering system 13 adds torque (assist torque) to the steering unit 4 by the actuator 13a to supplement the steering force, and steers the wheels 3 (automatic steering). The actuator 13a may steer one wheel 3 or may steer a plurality of wheels 3. Further, a torque sensor 13b detects, for example, torque that the driver gives to the steering unit 4.

As illustrated in FIG. 2, the vehicle 1 (the vehicle body 2) is provided with, for example, four imaging units 15a to 15d as the plurality of imaging units 15. The imaging unit 15 is a digital camera including an imaging element such as a charge coupled device (CCD) or a CMOS image sensor (CIS). The imaging units 15 can output moving image data (captured image data) at a predetermined frame rate. Each of the imaging units 15 includes a wide-angle lens or a fisheye lens, and can capture a range of, for example, 140° to 220° in the horizontal direction. Further, the optical axis of the imaging unit 15 may be set obliquely downward. Therefore, the imaging units 15 sequentially captures the environment around the vehicle 1 including the road surface on which the vehicle 1 is movable, the area where the vehicle 1 can be parked, and surrounding objects (obstacles, people, bicycles, automobiles, etc.), and output them as captured image data.

The imaging unit 15a is located, for example, at a rear end 2e of the vehicle body 2 and is provided on a lower wall portion of a rear trunk door 2h. The imaging unit 15b is located, for example, at a right end 2f of the vehicle body 2, and is provided on the right door mirror 2g. The imaging unit 15c is located, for example, on the front of the vehicle body 2, that is, at a front end 2c of the vehicle in the front-rear direction, and is provided on a front bumper or the like. The imaging unit 15d is located, for example, at a left end 2d of the vehicle body 2 and provided on the left door mirror 2g. The ECU 14 can perform arithmetic processing and image processing based on the captured image data obtained by the plurality of imaging units 15, generate images with wider viewing angles, and generate a virtual overhead image (a planar image) when the vehicle 1 is viewed from above.

In addition, the ECU 14 identifies a compartment line (for example, a white line) indicated on the road surface around the vehicle 1 from the captured image of the imaging units 15, and detects (extracts) a parking compartment defined by the compartment line.

In the present embodiment, as an example, as illustrated in FIG. 1 and FIG. 2, the vehicle 1 (the vehicle body 2) includes, as a plurality of distance-measuring units 16 and 17, for example, four distance-measuring units 16a to 16d and eight distance-measuring units 17a to 17h. Each of the distance-measuring units 16 (for long distance) and the distance-measuring units 17 (for short distance) is, for example, sonar (a sonar sensor, an ultrasonic detector) that emits ultrasonic waves and captures reflected waves. The ECU 14 can measure the presence or absence of and a distance from an object (an obstacle) located, for example, behind the vehicle 1 (the vehicle body 2) based on the detection result of the distance-measuring unit 17. Similarly, the presence or absence of and a distance from an object (an obstacle) located in front of the vehicle 1 can be measured by the distance-measuring unit 17 disposed on the front of the vehicle 1. Furthermore, the ECU 14 can measure the presence or absence of and a distance from an object (an obstacle) positioned in the direction of the side surface of the vehicle 1 (the vehicle body 2) based on the detection result of the distance-measuring unit 16.

In the present embodiment, as an example, as illustrated in FIG. 3, in a parking assistance system 100, in addition to the ECU 14, the monitor device 11, the steering system 13, the distance-measuring units 16 and 17, etc., a brake system 18, a steering angle sensor 19 (angle sensor), an accelerator sensor 20, a shift sensor 21, a wheel speed sensor 22, etc. are electrically connected to each other via an in-vehicle network 23 (electric communication line). The in-vehicle network 23 is configured as a controller area network (CAN) as an example. The ECU 14 can control the steering system 13, the brake system 18, and the like by transmitting a control signal through the in-vehicle network 23. The ECU 14 can receive, via the in-vehicle network 23, detection results of the torque sensor 13b, a brake sensor 18b, the steering angle sensor 19 (for front wheels 3F), the distance-measuring units 16 and 17, the accelerator sensor 20, the shift sensor 21, the wheel speed sensor 22, etc., and instruction signals (a control signal, an operation signal, an input signal, and data) from the operation input unit 10, etc.

As an example, the ECU 14 includes a central processing unit (CPU) 14a, a read only memory (ROM) 14b, a random access memory (RAM) 14c, a display controller 14d, a sound controller 14e, a solid state drive (SSD, a flash memory) 14f and the like. For example, the CPU 14a can execute various kinds of calculation processing such as image processing related to an image displayed on the display device 8, calculation of a movement route of the vehicle 1, and determination of the presence or absence of interference with an object. The CPU 14a can read out a program stored (installed) in a nonvolatile storage device, such as the ROM 14b, and execute arithmetic processing in accordance with the program. The RAM 14c temporarily stores various types of data used in calculation by the CPU 14a. In addition, the display controller 14d mainly performs, among the arithmetic processing in the ECU 14, image processing using image data obtained by the imaging units 15, and image processing of image data displayed on the display device 8 (for example, synthesis, etc.). In addition, the sound controller 14e mainly performs processing of voice data output from the sound output device 9 among the arithmetic processing in the ECU 14. The SSD 14f is a rewritable nonvolatile storage unit that can store data even when the power of the ECU 14 is turned off. Note that the CPU 14a, the ROM 14b, the RAM 14c, and the like can be integrated in the same package. Further, the ECU 14 may have a configuration in which another logical operation processor such as a digital signal processor (DSP), a logic circuit, or the like is used instead of the CPU 14a. Further, a hard disk drive (HDD) may be provided instead of the SSD 14f, and the SSD 14f and the HDD may be provided separately from the ECU 14.

The brake system 18 includes an anti-lock brake system (ABS) that suppresses the locking of the brake, a skid suppressing device (ESC: electronic stability control) that suppresses the skid of the vehicle 1 during cornering, and an electric brake system, a brake by wire (BBW), that enhances the braking force (performs brake assistance) and the like. The brake system 18 applies a braking force to the wheels 3 (vehicle 1) via an actuator 18a. The brake sensor 18b can detect the position of a brake pedal as a movable part. The brake sensor 18b includes a displacement sensor.

The steering angle sensor 19 is a sensor that detects a steering amount (a rotation angle) of the steering unit 4 (in the present embodiment, a steering wheel as an example), and is configured by using, for example, a Hall element. The ECU 14 acquires the steering amount of the steering unit 4 by the driver, the steering amount of respective wheels 3 at the time of parking assistance in which automatic steering is executed, and the like from the steering angle sensor 19 and executes various controls. Further, for example, when the braking operation unit 6 is operated during automatic steering, the ECU 14 can interrupt or cancel the automatic steering determining that it is a time not suitable for the automatic steering. The torque sensor 13b detects the torque that the driver gives to the steering unit 4.

The accelerator sensor 20 is a sensor that detects the position of the movable part of the acceleration operation unit 5, for example. The accelerator sensor 20 can detect the position of an accelerator pedal as a movable part. The accelerator sensor 20 includes a displacement sensor.

The shift sensor 21 is, for example, a sensor that detects the position of the movable part of the shift operation unit 7. The shift sensor 21 can detect the position of a lever, an arm, a button, or the like as a movable part. The shift sensor 21 may include a displacement sensor or may be configured as a switch. For example, the ECU 14 can start the assistance control when the movable part is set to reverse, or can end the assistance control when it is changed from reverse to forward.

The wheel speed sensor 22 is a sensor that detects the amount of rotation of the wheels 3 and the number of rotations per unit time. The wheel speed sensor 22 outputs a wheel speed pulse number indicating the detected number of rotations as a sensor value. The wheel speed sensor 22 can be configured using, for example, a Hall element. The ECU 14 calculates the speed, the movement amount, and the like of the vehicle 1 based on the sensor values acquired from the wheel speed sensor 22, and executes various controls. The wheel speed sensor 22 may be provided in the brake system 18. In this case, the ECU 14 acquires the detection result of the wheel speed sensor 22 via the brake system 18. The brake system 18 can detect the brake lock, the idle rotation of the wheels 3, signs of skidding, and the like from the difference in rotation between the left and right wheels 3 based on the detection result of the wheel speed sensor 22, and execute various controls.

Note that the configuration, arrangement, electrical connection form, and the like of the various sensors and actuators described above are merely examples, and can be variously set (changed).

The ECU 14 realizes a parking assistance apparatus as one of various control devices. As an example, the ECU 14 captures an image of the surrounding area of the vehicle 1 using the imaging units 15 while the vehicle 1 is moving at a low speed. Then, a parking target position that is an area where the vehicle 1 can be parked is detected from the captured image obtained from the imaging units 15. At this time, the relationship between the parking target position and the position of the vehicle 1 is indicated using relative coordinates.

Conventionally, when the vehicle is moving, the coordinates indicating the parking target position are also moved with the movement of the vehicle, and the initial parking target position is deviated from the recognized coordinate position. As a result, when the parking assistance is executed from the position (the current position) where the vehicle has moved, the vehicle is guided to the deviated coordinates (the vehicle is deviated parking target position with the movement of the vehicle). In other words, the final parking completion position is different from the position where the captured image is captured (the parking position to be guided recognized by the driver).

Moreover, conventionally, there is a restriction on the steering angle of the vehicle in generating the movement route to the parking target position. Thus, when the steering angle of the vehicle is not within the allowable range, it is not able to start the parking assistance for the vehicle. In other words, when the vehicle is in a stopped state, the stationary control can be performed, so that it is able to start the parking assistance regardless of the current steering angle of the vehicle.

Therefore, in the parking assistance system 100 of the present embodiment, it is realized that the parking assistance to the parking target position is started regardless of the current steering angle of the vehicle 1. Furthermore, in the parking assistance system 100, the control is proposed, in which it is possible to start the parking assistance even when the vehicle 1 is moving.

In the parking assistance system 100 of the present embodiment, after generating the movement route to the parking target position in the case of the steering angle ‘0’, the movement route is corrected by using a correction route where the vehicle is movable to the position included in the movement route at the current steering angle of the vehicle 1.

In the parking assistance system 100 of the present embodiment, information representing the correction route where the vehicle is movable to a position included in the movement route is stored in advance for each steering angle. Then, information representing the correction route is read out based on the current steering angle, and the movement route is corrected with the read correction route. As a result, regardless of the current steering angle of the vehicle 1, the vehicle 1 can be guided to the parking target position according to the corrected movement route corrected by the correction route.

Furthermore, in the parking assistance system 100 of the present embodiment, for example, when the vehicle 1 is traveling at a low speed, the parking target position (relative coordinate position) when the captured image for the current position of the vehicle 1 is displayed is determined during the period after a captured image (for example, an image on which a parking frame image is superimposed) is displayed on the display device 8 before the captured image is displayed (captured) next. For example, based on the movement amount obtained by the movement of the vehicle 1 and the positional relationship (a relative position) between the vehicle 1 when the captured image is captured and the parking target position, the parking target position (a relative coordinate position) when the captured image for the current position of the vehicle 1 is displayed is determined. Then, when a parking assistance start request is made via an operation unit 14g provided as an input device, the vehicle 1 is guided (the parking assistance is performed) based on the parking target position determined at the current position of the vehicle 1. As a result, even when the parking assistance is started during the low-speed movement, the vehicle 1 can be guided to the parking target position with a small deviation from the initial recognition position.

The SSD 14f included in the ECU 14 is provided with a circumference information storage unit 46 and a correction route storage unit 48.

In the present embodiment, a movement route is generated by combining part of a plurality of circumferences and a straight line. Therefore, the circumference information storage unit 46 of the present embodiment stores circumference information that functions as part of the movement route of the vehicle 1.

The correction route storage unit 48 stores, with respect to individual steering angles other than the steering angle ‘0’, information representing a correction route where the vehicle is movable from the current position (initial position) of the vehicle to a position included in the movement route by performs steering angle control from each of the individual steering angle. In the present embodiment, an example in which a movement route is generated when the steering angle is ‘0’ as the given steering angle will be described. The steering angle at the time of generating the movement route is, however, not limited to the steering angle ‘0’.

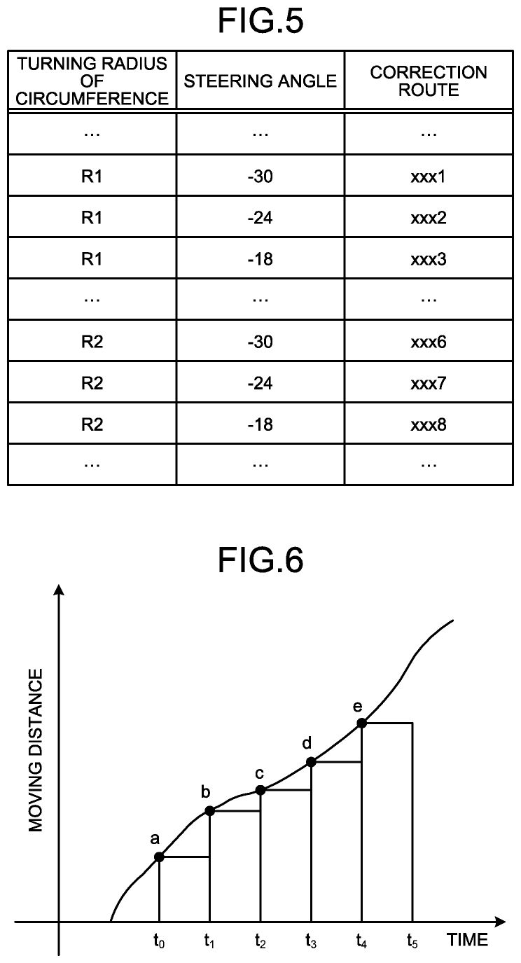

FIG. 5 is a diagram illustrating a table structure of the correction route storage unit 48 of the present embodiment. In the example illustrated in FIG. 5, the turning radius of the circumference, the steering angle, and the correction route information are stored in association with each other. The turning radius of the circumference indicates the turning radius of the circumference information used for generating the movement route. The steering angle indicates a steering angle of the vehicle 1 at the start of parking assistance. The correction route information is information about a route where the vehicle is movable from the current position of the vehicle to a position included in the movement route at the steering angle. Thus, in the present embodiment, a correction route is provided for each circumferential turning radius and each steering angle. The process using the correction route will be described later. Note that the correction route information is not described because an appropriate route is set according to the shape of the vehicle, the mobility of the vehicle, and the like.

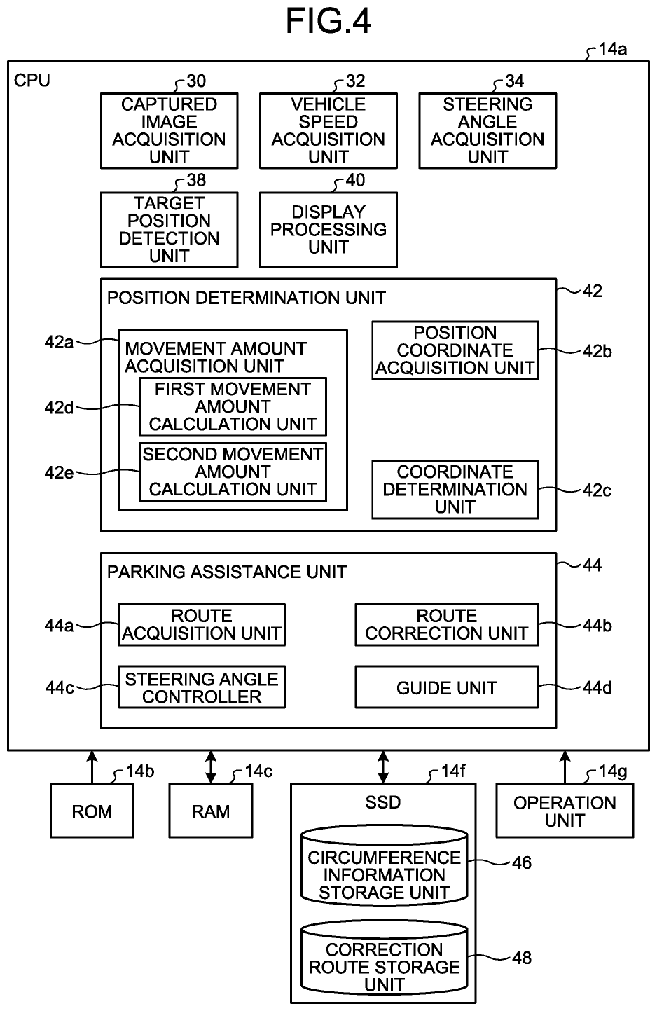

Returning to FIG. 4, in order to perform the correction (the determination) of the parking target position described above, or execute the correction of the movement route by the correction route, the CPU 14a included in the ECU 14 includes a plurality of modules whose functions are implemented by reading the program installed and stored in a storage device such as the ROM 14b and executing the program. As illustrated in FIG. 4, the CPU 14a includes, for example, a captured image acquisition unit 30, a vehicle speed acquisition unit 32, a steering angle acquisition unit 34, a target position detection unit 38 (a detector), a display processing unit 40 (a display unit), a position determination unit 42, a parking assistance unit 44 and the like.

The captured image acquisition unit 30 acquires (captures) captured image data output from the imaging units 15 provided in the vehicle 1 and imaging the surroundings of the vehicle 1 at predetermined time intervals via the display controller 14d. Then, arithmetic process is performed on the captured image. FIG. 6 is a diagram illustrating the relationship between the capture timing of the captured image acquisition unit 30 in the vehicle 1 moving at a low speed, the moving distance of the vehicle 1, and the use period of the captured image that has been captured. For example, the captured image acquisition unit 30 sequentially captures captured images at predetermined time intervals (for example, 100 ms intervals). Therefore, a captured image around the vehicle 1 at a vehicle position “a” is acquired at time t₀, and a captured image around the vehicle 1 at a vehicle position “b” is acquired at time t₁. That is, the captured image data captured at time t₀ is used for coordinate calculation processing, display processing, and the like between time t₀ and time t₁. Then, the captured image data acquired at time t₁ is available after time t₁. Therefore, for example, the surrounding image at the vehicle position “a” is displayed as a still image between times t₀ and t₁. In this case, image processing may be performed intermittently at predetermined time intervals, and the deviation of the parking target position is corrected during this time, which will be described later. Thus, it is possible to improve the accuracy of the parking assistance (vehicle guidance) while reducing the processing load. The same applies to time t₁ to t₂, time t₂ to t₃, and the like.

The vehicle speed acquisition unit 32 calculates the vehicle speed of the vehicle 1 based on the detection value of the wheel speed sensor 22, and executes various controls. The vehicle speed acquisition unit 32 determines the current vehicle speed of the vehicle 1 based on the smallest detection value among the detection values of the four wheel speed sensors 22 provided corresponding to respective wheels 3, for example.

The steering angle acquisition unit 34 acquires a steering angle related to the state of the tire (the front wheels 3F) output from the steering angle sensor 19 of the vehicle 1. When the driver operates the steering unit 4, the steering angle acquisition unit 34 acquires information representing the steering angle of the tire (the front wheels 3F) controlled by the steering system 13 according to the operation of the steering unit 4 by the driver.

The target position detection unit 38 detects a parking target position that is the destination of the vehicle 1. The target position detection unit 38 of the present embodiment detects a line indicating a parking compartment (for example, a white line, or a line indicated by another color, or a rope etc.) included in the captured image indicating the surroundings of the vehicle 1 captured by the captured image acquisition unit 30, and sets, as the parking target position, either one of the area surrounded by a pair of lines of the detected lines.

The display processing unit 40 performs processing for displaying information on the display device 8. For example, the display processing unit 40 superimposes and displays the parking frame image set by the target position detection unit 38 on, for example, an overhead image indicating the surroundings of the vehicle 1 acquired by the captured image acquisition unit 30. Note that the overhead image can be created by performing known viewpoint conversion processing and synthesis processing on the captured image data captured by the imaging units 15a to 15d. The display processing unit 40 updates the overhead image based on the captured image every time the captured image acquisition unit 30 captures a new captured image, and updates the superimposed state of the parking frame image set by the target position detection unit 38.

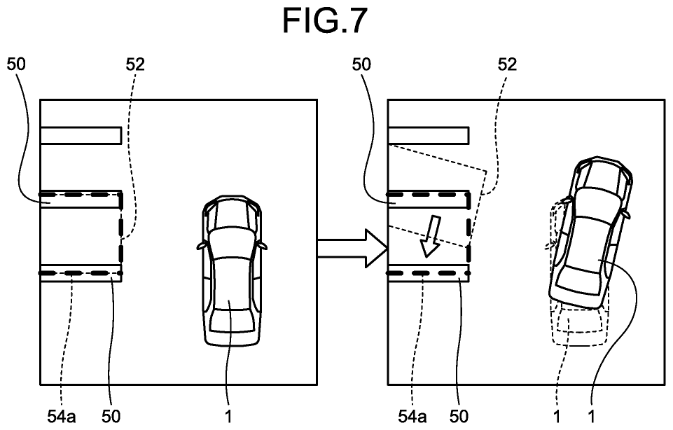

FIG. 7 is a diagram illustrating the relationship between a white line 50, a parking target position 52, a parking frame 54a, and the vehicle 1 in overhead view. The parking frame 54a is an area corresponding to a parking frame displayed as an overhead image on the display device 8. In the case of FIG. 7, the parking target position 52 is indicated by a frame shape for the sake of explanation as in the parking frame 54a, but the ECU 14 defines the parking target position 52 by the coordinates, for example. Therefore, when the vehicle 1 is guided to the parking target position 52, the reference point of the vehicle 1 (for example, a point defined by the center position of the front wheel shaft) is guided to the coordinates defined as the parking target position 52. The left diagram of FIG. 7 illustrates a state when the captured image acquisition unit 30 captures a captured image at the position of the vehicle 1 moving at a low speed and the parking target position 52 is calculated. In this case, the parking target position 52 and the parking frame 54a are substantially the same position. Note that the position (coordinates) of the parking target position 52 and the position of the vehicle 1 are indicated by the relative coordinates. Therefore, when the vehicle 1 moves to the position illustrated in the right diagram of FIG. 7 (the position of the vehicle 1 indicated by the solid line), the parking target position 52 (relative coordinates) moves with the movement of the vehicle 1. As a result, the position of the parking target position 52 is deviated (coordinate deviation) from the position of the parking frame 54a superimposed on the white line 50. The position determination unit 42 performs a process of correcting the deviation of the coordinates of the parking target position 52.

The position determination unit 42 includes a movement amount acquisition unit 42a, a position coordinate acquisition unit 42b, a coordinate determination unit 42c, and the like. As mentioned above, the captured image acquisition unit 30 captures the captured image captured by the imaging units 15 at predetermined time intervals, and the display processing unit 40 updates the overhead image displayed on the display device 8 (the image on which the parking frame 54a is superimposed) corresponding to the capture interval. That is, the overhead image (the white line 50 and the parking frame 54a) displayed at the time of the previous capture is displayed on the display device 8 until the next capture is executed. On the other hand, in a case where the vehicle 1 moves when the white line 50 and the parking frame 54a are continuously displayed as an overhead image, the parking target position 52 indicated by the relative coordinates based on the vehicle 1 moves with the movement thereof. Therefore, when the vehicle 1 moves before the overhead image (white line 50, parking frame 54a) is updated, the position determination unit 42 detects the movement amount, and performs correction so as to return the parking target position 52 moved on the relative coordinate system to the coordinates of the parking frame 54a (position which is recognized as the parking target position 52 at the time of capture) using the movement amount.

The movement amount acquisition unit 42a includes a first movement amount calculation unit 42d, a second movement amount calculation unit 42e, and the like. The first movement amount calculation unit 42d calculates a first movement amount by which the vehicle 1 moves at a predetermined processing cycle during a period from when the overhead image with the parking frame 54a superimposed on the display device 8 is displayed to when the captured image is captured next and displayed. In this case, when the display of the display device 8 is switched to the overhead image, that is, when the display of the display device 8 is switched to the screen for displaying the parking frame image, the ECU 14 determines the absolute coordinate system reference (the origin), and obtains the current coordinates (absolute coordinates) of the vehicle 1 from the origin to calculate the first movement amount.

In practice, it takes a predetermined processing time for detecting by the target position detection unit 38 the parking target position 52 after the captured image acquisition unit 30 captures the captured image and superimposing the parking frame 54a by the display processing unit 40. When the vehicle 1 is moving during this processing time, the parking target position 52 indicated by the relative coordinates is deviated. For example, when an overhead image without the parking frame 54a is displayed by switching the screen of the display device 8 and the user recognizes (visually) a space (an area) at which the vehicle may be parked, the parking target position 52 is deviated based on the movement amount of the vehicle 1 before the parking frame 54a is displayed. Then, the second movement amount calculation unit 42e of the movement amount acquisition unit 42a calculates, as a second movement amount, a distance by which the vehicle 1 moves during the processing period for detecting the parking target position 52 from the capture of the captured image. In this way, by taking count of the second movement amount in addition to the first movement amount as the movement amount of the vehicle 1, the parking target position 52 for performing parking assistance can be calculated more accurately. While the processing time at this time is a substantially constant according to the capability of the CPU 14a, the second movement amount also increases when the moving speed of the vehicle 1 is fast. In the embodiment, an example of correcting the deviation of the coordinates by using the first movement amount and the second movement amount is described. Alternatively, either the first movement amount or the second movement amount may be used to correct the deviation of the coordinates, and thereby the coordinate deviation can be reduced.

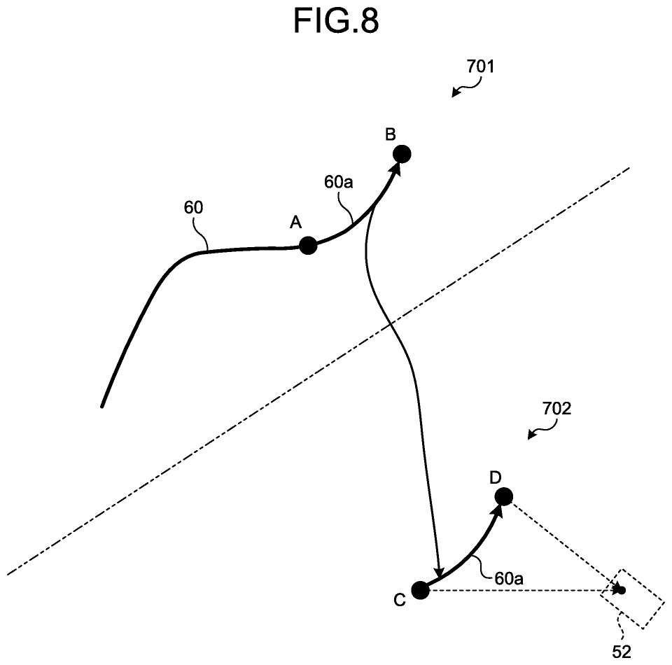

FIG. 8 is a schematic diagram for explaining an example of the correction calculation of the parking target position 52. In FIG. 8, an absolute coordinate system 701 indicating a movement locus 60 of the vehicle 1 moving at a low speed and a relative coordinate system 702 indicating the position of the vehicle 1 and the position of the parking target position 52 are illustrated side by side. In the absolute coordinate system 701, the coordinates of the moving vehicle 1 can be obtained based on an optional position of the moving vehicle 1 by using the movement amount and the steering angle from the position. The position coordinate acquisition unit 42b acquires a coordinate A (an absolute coordinate) of the vehicle 1 where the vehicle 1 captures a surrounding captured image, and acquires, as the current position of the vehicle 1, a coordinate B (an absolute coordinate) of the vehicle 1 where a request for parking assistance start (request for guiding the vehicle 1 to the parking target position 52) is made via the operation unit 14g or the like. The relative coordinate system 702 is a coordinate system that represents the relationship (a positional relationship) between the vehicle 1 and the parking target position 52. The position coordinate acquisition unit 42b of the present embodiment acquires the positional relationship from the parking frame 54a (a position corresponding to the parking target position 52) appearing in the captured image. The position coordinate acquisition unit 42b acquires the coordinates (relative coordinates) of the parking target position 52 based on the position of the vehicle 1 when the captured image is captured. Thereby, the position (the coordinate C) of the vehicle 1 based on the parking target position 52 can be determined. The coordinate determination unit 42c calculates a coordinate D (a relative coordinate) indicating a relative relationship between the current position of the vehicle 1 and the parking target position 52 when the captured image is captured based on the positional relationship between the vehicle 1 and the parking target position 52 when the coordinates A, B, C, and C are acquired. In this case, the coordinate determination unit 42c calculates a coordinate D by performing a known calculation method, for example, a coordinate rotation process or a movement process. Schematically, as illustrated in FIG. 8 the position (the coordinate D) of the vehicle 1 based on the parking target position 52 can be calculated (determined) by cutting out the portion of a partial movement locus 60a defined by the coordinates A and B, performing the rotation process and the movement process, and connecting the partial movement locus 60a to the coordinate C.

The parking assistance unit 44 includes a route acquisition unit 44a, a route correction unit 44b, a steering angle controller 44c, a guide unit 44d, and the like, and performs control for guiding the vehicle 1 to the parking target position 52.

When a request for guiding the vehicle 1 to the parking target position 52 is made via the operation unit 14g or the like, the route acquisition unit 44a acquires a movement route for guiding from the current position (an initial position) of the vehicle 1 to the parking target position 52 determined by the coordinate determination unit 42c. The route acquisition unit 44a of the present embodiment acquires the movement route from a current position (an initial position) 951 of the vehicle 1 to the parking target position 52 when the vehicle 1 has the steering angle ‘0’ (in other words, the steering wheel rotation angle ‘0’).

In the present embodiment, an example in which the route acquisition unit 44a selects a circumference suitable for the movement route and obtains a combination of the circumference and the straight route as the movement route will be described, but the movement route acquisition method is limited. For example, the route acquisition unit 44a may calculate (generate) a route based on a predetermined condition and acquire the calculated route as a movement route.

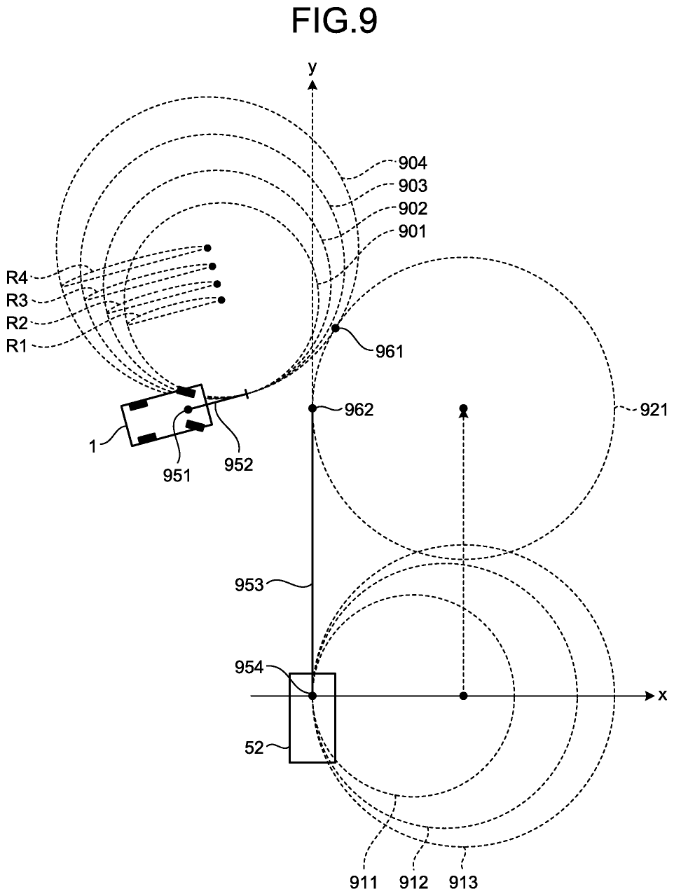

FIG. 9 is a diagram illustrating a movement route generation method by the route acquisition unit 44a of the present embodiment. It is assumed that the circumference information storage unit 46 stores a first circumference 901 (the turning radius R1), a second circumference 902 (the turning radius R2), a third circumference 903 (the turning radius R3), and a fourth circumference 904 (the turning radius R4) on the vehicle side illustrated in FIG. 9, and a first circumference 911, a second circumference 912, and a third circumference 913 on the parking area side.

The route acquisition unit 44a selects a circumference that passes through the initial position 951 and that is tangential to a first straight line 952 extending in the traveling direction of the vehicle 1 from among the circumferences 901 to 904. In the example illustrated in FIG. 9, it is assumed that the fourth circumference 904 is selected.

In the present embodiment, the center position of the front wheel shaft of the vehicle 1 is regarded as the position of the vehicle 1, but the position of the vehicle 1 is not limited to this. For example, the position of the center of gravity of the vehicle 1 may be regarded as the position of the vehicle 1.

The route acquisition unit 44a selects, from among the circumferences 911 to 913, a circumference that is tangential to a second straight line 953 extending from the parking target position 52 in the exit direction and that passes through the parking target position 52. In the example illustrated in FIG. 9, it is assumed that the third circumference 913 is selected.

In the example of FIG. 9, passing through the parking target position 52 means passing through a parking target position 954 of the vehicle 1 in the parking target position 52, that is, the center position of the front wheel shaft of the vehicle 1 when the vehicle 1 is parked.

Hereinafter, as illustrated in FIG. 9, description will be made using a coordinate system in which the second straight line 953 is the y-axis, and a straight line that passes through the parking target position 52 and is orthogonal to the y-axis is the x-axis. The exit direction of the vehicle 1 is the positive direction of the y-axis.

The route acquisition unit 44a sets a circumference 921 that is obtained by shifting the circumference 913 until the circumference 913 is tangential to the circumference 904 in the positive direction of the y-axis. As illustrated in FIG. 9, the circumference 904 and the circumference 921 are tangential to each other at a position 961.

Then, the route acquisition unit 44a acquires a movement route where part of the circumference 904 and part of the circumference 921 are functioned as part of the movement route.

Subsequently, as illustrated in FIG. 9, the route acquisition unit 44a generates a movement route where the vehicle 1 is moved forward from the initial position 951 to the position 961 along the circumference 904, the vehicle 1 is moved backward along the circumference 921 from the position 961 to a position 962 being a tangential point between the circumference 921 and the y-axis, and the vehicle 1 is moved backward from the position 962 to the parking target position 52 along the y-axis.

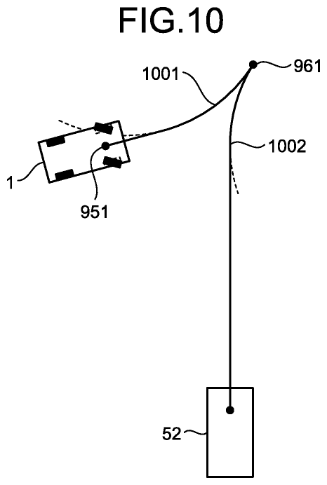

FIG. 10 is a diagram illustrating a movement route acquired by the route acquisition unit 44a of the present embodiment. As illustrated in FIG. 10, a movement route is generated by combining a movement route 1001 including part of the circumference 904 and a movement route 1002 including part of the circumference 921. Note that the present embodiment shows an example of a movement route acquisition method, and any other method may be used as long as it is a movement route acquisition method including part of the circumference.

The route acquisition unit 44a in the present embodiment acquires the movement route when the vehicle 1 has the steering angle ‘0’. Therefore, the route correction unit 44b of the present embodiment corrects the acquired movement route according to the current steering angle. Thereby, the vehicle 1 can be guided to the parking target position 52 regardless of the current steering angle.

The route correction unit 44b corrects, based on the steering angle acquired by the steering angle acquisition unit 34, the movement route with a correction route where the vehicle is movable to a position on the movement route at the acquired steering angle in accordance with the correction route information stored in the correction route storage unit 48. Thereby, the route correction unit 44b acquires a corrected movement route from the current position of the vehicle 1 to the parking target position.

The correction route storage unit 48 of the present embodiment holds correction route information for each turning radius of the circumference. That is, the correction route storage unit 48 stores correction route information for each steering angle for each of the turning radii R1 to R4 of the circumferences 901 to 904 on the vehicle 1 side illustrated in FIG. 9.

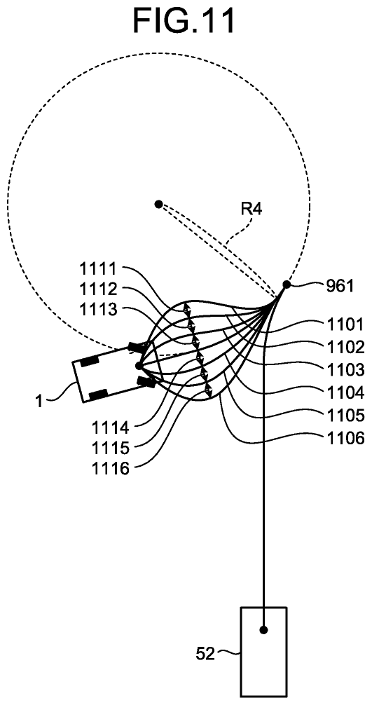

FIG. 11 is a diagram illustrating correction route information for each steering angle, which is stored in the correction route storage unit 48 and associated with the turning radius R4 of the circumference. As illustrated in FIG. 11, the correction route storage unit 48 stores correction routes 1101 to 1106 according to the turning radius R4. Then, the route correction unit 44b extracts, from the correction route storage unit 48, correction route information associated with the turning radius R4 used to generate the movement route and the current steering angle. The route correction unit 44b acquires a corrected movement route where the vehicle is moved to a position on the movement route acquired by the route acquisition unit 44a in accordance with the correction route indicated by the correction route information and, after that, the vehicle is moved from the position to the parking target position in accordance with the movement route acquired by the route acquisition unit 44a.

When all pieces of correction route information based on the steering angle acquired by the steering angle acquisition unit 34 are stored in the correction route storage unit 48, the storage amount increases. Therefore, the correction route storage unit 48 of the present embodiment is provided with correction route information for each given steering angle.

In addition, when the steering angle acquired by the steering angle acquisition unit 34 is between a first steering angle and a second steering angle stored in the correction route storage unit 48, the route correction unit 44b of the present embodiment selects a steering angle with a large absolute value between the first steering angle and second steering angle. Then, the route correction unit 44b corrects the movement route with the correction route in accordance with the correction route information based on to the selected steering angle, and thereby acquires a new corrected movement route. That is, since it is difficult to control the movement of the vehicle 1 so as to follow the correction route with the steering angle whose absolute value is smaller than the current steering angle, the above-described control is performed in the present embodiment.

In addition, the route correction unit 44b of the present embodiment corrects, based on the steering angle acquired by the steering angle acquisition unit 34, the movement route with a correction route where the vehicle is movable to a position included in the movement route at the acquired steering angle in accordance with the correction route information stored in the correction route storage unit 48 only when the speed of the vehicle 1 acquired by the vehicle speed acquisition unit 32 is within a predetermined speed range. As a predetermined speed range, for example, a vehicle speed of 1 to 2 km/h can be conceivable. An appropriate speed range may set in consideration of parking target position correction accuracy and the processing time for correcting the movement route.

As correction routes associated with the turning radius R4 of the circumference for each steering angle, the correction route storage unit 48 of the present embodiment stores the correction route information in which the widths 1111 to 1116 for the respective correction routes are made uniform with each other. In this way, the widths 1111 to 1116 for the respective correction route are made uniform. Those widths are determined depends on the embodiment so that an appropriate correction route can be selected when the steering angle acquired by the steering angle acquisition unit 34 is between a plurality of steering angles stored in the correction route storage unit 48. Thereby, the correction of an appropriate movement route can be implemented. The correction route information storage method of the present embodiment is shown as an example, and for example, the correction route information may be stored for respective given steering angles.

The steering angle controller 44c calculates a steering angle for moving the vehicle 1 along the corrected movement route and controls the steering system 13 to become the calculated steering angle. This processing realizes automatic steering.

The guide unit 44d performs an operation guidance (switching between D position and R position) for the shift operation unit 7 (a shift lever) and an operation amount guidance for the acceleration operation unit 5 (an accelerator pedal) so that the user (a driver) can move the automatically steered vehicle 1 along the corrected movement route. In addition, the guide unit 44d performs guidance, such as validation of surrounding safety and alerting based on surrounding conditions, by voice via the sound output device 9, display via the display device 8, or the like.

In the parking assistance in the present embodiment, as an example, automatic steering is implemented by the CPU 14a, and other operations are performed by the user according to a guidance by the guide unit 44d. However, the present invention is not limited to this. For example, in addition to steering, the operation of the acceleration operation unit 5 may be automatically performed under the control of the CPU 14a. Similarly, the operation of the shift operation unit 7 may be automatically performed.

As described above, in the present embodiment, correction route information according to the current steering angle is read out from the correction route storage unit 48, and the movement route acquired by the route acquisition unit 44a is corrected with the correction route in accordance with the correction route information. Thereby, the vehicle 1 can be guided to the parking target position regardless of the current steering angle. Thus, the temporary stop for returning a steering angle is unnecessary. In other words, when parking assistance is started, the vehicle 1 can be guided to the parking target position 52 without temporarily stopping the vehicle 1 regardless of the current steering angle.

When the movement control is performed without temporarily stopping the vehicle 1, there is a possibility that a deviation occurs in the parking target position 52 set by the target position detection unit 38 based on the relative distance to the vehicle 1. In contrast, the position determination unit 42 of the present embodiment corrects the parking target position 52 according to the movement amount of the vehicle 1. As a result, even in a state that the vehicle 1 has moved, it is possible to accurately acquire, based on the current position of the vehicle 1, the position (coordinate D) of the parking target position 52 where the captured image acquisition unit 30 captures the captured image, and the vehicle 1 can be more accurately guided to the parking position recognized by the user on the display device 8.

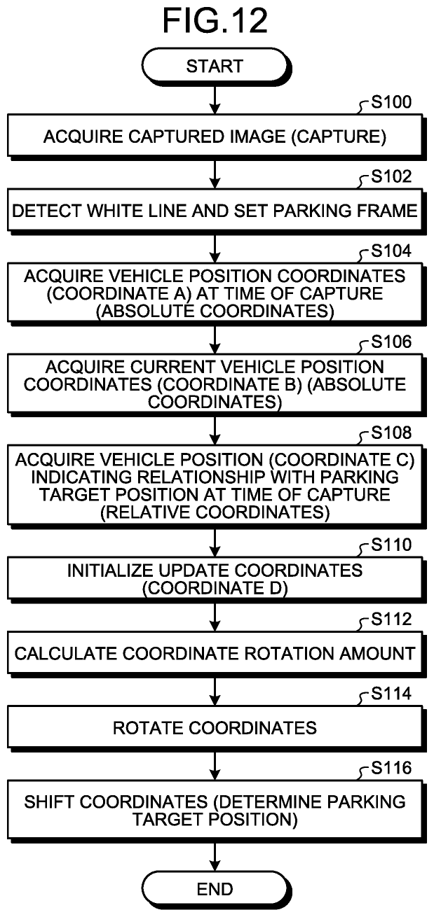

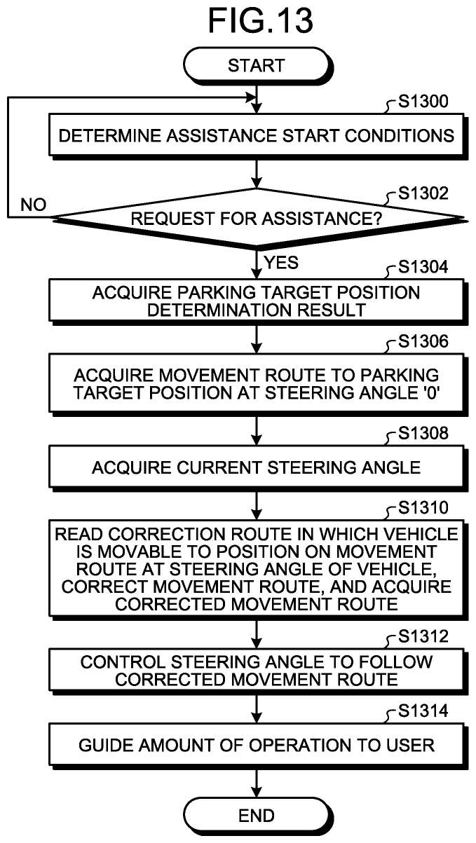

An example of the coordinate recognition process (correction process) of the parking target position 52 and an example of the parking assistance control process by the parking assistance system 100 configured as described above will be described with reference to FIGS. 12 and 13. The first processing flow for searching for a parking available area and determining the parking target position 52 illustrated in FIG. 12 and the second processing flow for executing parking assistance illustrated in FIG. 13 are performed at different processing intervals.

When the vehicle 1 enters the parking area or the like by using the information provided by, for example, the navigation system or the like, and a speed of the vehicle 1 is less that a predetermined speed (for example, 10 km/h or less), the ECU 14 activates the parking available area search mode automatically or manually and captures the captured image by the captured image acquisition unit 30 (S100). Subsequently, the target position detection unit 38 extracts a white line portion from the captured image that has been captured, extracts the parking target position 52 as an area where the vehicle 1 can be parked from the area surrounded by the pair of white lines 50 of the detected white lines, and sets the parking frame 54a (S102).

Subsequently, the position coordinate acquisition unit 42b acquires the coordinates A (absolute coordinates) of the vehicle 1 when the vehicle 1 captures a surrounding captured image (S104). Further, the position coordinate acquisition unit 42b acquires the coordinates B (absolute coordinates) indicating the current position of the vehicle 1 (S106). The position coordinate acquisition unit 42b acquires the current position of the vehicle 1 based on, for example, the elapsed time since the captured image is captured, the vehicle speed, the steering direction, and the like.

The position coordinate acquisition unit 42b acquires, as the relationship between the vehicle 1 and the parking target position 52, the coordinates C (relative coordinates) indicating the positional relationship between the vehicle 1 and the parking target position 52 where the captured image is captured (S108).

Subsequently, the coordinate determination unit 42c initializes the information of the coordinates D corrected in the previous determination process of the parking target position 52 (initialization of updated coordinates) (S110). The coordinate determination unit 42c then calculates the amount of rotation θ between the coordinate systems in order to eliminate the deviation in the coordinate system between the absolute coordinates indicating the position of the vehicle 1 and the relative coordinates indicating the positional relationship between the vehicle 1 and the parking target position 52 (S112). In this case, the coordinate determination unit 42c can calculate the rotation amount θ using a known method. For example, the coordinate determination unit 42c can calculate the rotation amount θ by obtaining a difference (diff_θ) between the coordinate A of the absolute coordinate system 701 and the coordinate C of the relative coordinate system 702 illustrated in FIG. 8. In this case, diff_θ=coordinate C(θ)-coordinate A(θ). Then, the coordinate determination unit 42c rotates the partial movement locus 60a defined by the coordinates A and the coordinates B illustrated in FIG. 8 (S114). The coordinate rotation can also be performed using known methods. In this case, each of the x coordinate and the y coordinate is rotated.

D_tem point(x)=(B point(x)−A point(x)*cos(diff_θ))−(B point(y)−A point(y)*sin(diff_θ))

D_tem point(y)=(B point(x)−A point(x)*sin(diff_θ))+(B point(y)−A point(y)*cos(diff_θ))

D_tem point(θ)=B point(θ)−A point(θ)

The coordinate determination unit 42c shifts the coordinates by using the calculated D_tem point(x), D_tem point(y), D_tem point(θ), and determines the coordinate D (a relative coordinate) indicating a relative relationship between the current position of the vehicle 1 and the parking target position 52 where the captured image is captured (S116).

D point(x)=D_tem point(x)+C point(x)

D point(y)=D_tem point(y)+C point(y)

D point(θ)=D_tem point(θ)+C point(θ)

Next, the parking assistance control procedure will be described with reference to FIG. 13. The parking assistance unit 44 constantly performs a determination process of determining whether the parking assistance start condition is satisfied during the parking available area search mode (S1300). The parking assistance start condition is a condition for determining whether guidance by automatic steering may be started. For example, it may be a condition for determining whether the vehicle speed is sufficiently reduced (for example, whether the vehicle speed is 1 to 2 km/h or less), whether there are any abnormalities in various sensors and various actuators, or the like. In the support start condition determination process, when parking assistance start conditions are not met, for example, when the vehicle speed is not sufficiently reduced, or a sensor is abnormal, the parking assistance unit 44 invalidates the input of the operation unit 14g that accepts an operation for requesting the parking assistance, and puts the parking assistance on hold.

When the parking assistance start condition is satisfied, the parking assistance unit 44 determines whether a support request has been made via the operation unit 14g or the like (S1302). When it is determined that the support request has not been made via the operation unit 14g or the like (S1302: No), the process is performed again from S1300.

On the other hand, when the parking assistance unit 44 determines that the support request has been made (S1302: Yes), the route acquisition unit 44a of the parking assistance unit 44 acquires the determination result of the parking target position 52 in S116 (S1304).

Then, the route acquisition unit 44a acquires the movement route from the current position of the vehicle 1 to the determined (corrected) parking target position 52 in the case of the steering angle ‘0’ (S1306).

The steering angle acquisition unit 34 acquires the steering angle of the tire (front wheel) of the current vehicle 1 (S1308).

The route correction unit 44b reads, from the correction route storage unit 48, correction route information in which the vehicle is movable to a position on the movement route corresponding to the steering angle of the current vehicle 1 acquired in S1308, and corrects the movement route with the correction route indicated by the correction route information to acquire a corrected movement route (S1310).

Then, the steering angle controller 44c performs the steering angle control by the steering system 13 such that the vehicle follows the corrected movement route acquired in S1310 (S1312).

Then, the guide unit 44d guides to the user the operation of the shift operation unit 7 (a shift lever) and the operation amount of the acceleration operation unit 5 (an accelerator pedal) so that the vehicle 1 can be moved along the guidance route (S1314).

In the present embodiment, by performing the control described above, it is possible to realize the start of parking assistance for moving the vehicle 1 to the parking target position regardless of the current steering angle of the vehicle 1. Further, since the vehicle can be moved to the parking target position regardless of the current steering angle, the vehicle 1 parking assistance to the parking target position can be realized when a speed of the vehicle 1 is within a predetermined speed range (for example, 1 to 2 km/h).

In the present embodiment, the case of correcting the movement route to the parking target position of the vehicle 1, but the present embodiment does not limit the target position as the destination to the parking target position. For example, the target position may be a turning point or another position.

Further, in the parking assistance system 100 of the present embodiment, when the vehicle 1 is traveling within a predetermined speed range (for example, 1 to 2 km/h), the parking target position 52 is corrected sequentially based on the movement amount of the vehicle 1. In addition, the corrected movement route to the parking target position of the vehicle 1 can be acquired without imposing restrictions on the current steering angle of the moving vehicle 1.

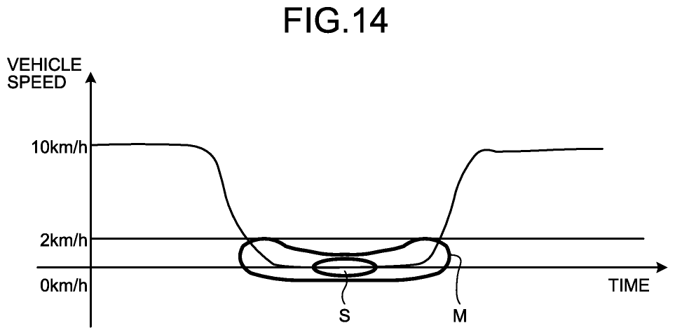

Therefore, as illustrated in FIG. 14, the parking assistance can be started also in a low-speed traveling area M including a stopping area S, compared to the conventional system in which that the parking assistance can be started only in the stopping area S. As a result, for example, the parking assistance can be started quickly even when there is a following vehicle, and smoother guidance can be performed.

### Modification 1

In embodiment mentioned above, the example in which the correction routes according to the steering angle are stored for every circumference is demonstrated. However, the forward traveling section from the current position of the vehicle 1 to the position included in the movement route may not differ so much among the circumferences.

Therefore, as a modification, the correction route storage unit 48 may store correction route information according to only the steering angle. As described above, in the modified example, it is sufficient to store the correction route information according to only the steering angle, so that the storage capacity can be reduced.

In the embodiment and the modification described above, the correction route according to the steering angle is read out from the correction route storage unit 48 to correct the movement route. As a result, the corrected movement route from the initial position of the vehicle 1 to the target position can be acquired regardless of the current steering angle of the vehicle 1. Thus, the restriction of the steering angle during the parking assistance, which has conventionally occurred, can be reduced.

In the embodiment and the modification described above, the movement route can be corrected by reading out the correction route from the correction route storage unit 48. Thus, it is not necessary to calculate the correction route, and it is possible to realize the reduction of the processing burden and quickly correction of the movement route.

In the above-described embodiment and modification, by acquiring a corrected movement route according to the current steering angle of the vehicle 1, it is possible to start the parking assistance despite the fact that the vehicle 1 is moving, and the vehicle 1 can be moved to the parking target position.

In the present embodiment, in order to correct the parking target position, the process is performed when the vehicle 1 is traveling within a predetermined speed range (for example, 1 to 2 km/h). Robustness related to speed can be improved because the correction route according to the steering angle is used. In the embodiment described above, the example is described, the parking assistance is started when the speed is 1 to 2 km/h in order to also correct the parking target position. Alternatively, when the parking target position can be determined, it is possible to perform control the vehicle 1 to move along the corrected movement route even if the speed is 1-2 km/h or more.

### Modification 2

In the embodiment and the modification described above, by correcting the acquired movement route with the correction route when vehicle 1 is moving at a low speed, the vehicle 1 is moved to the parking target position 52 according to the corrected movement route corrected by the correction route without stopping the vehicle 1. As in the above-described embodiments and modifications, the method is not limited to the correction method using the correction route, and the control of whether correction is performed using the correction route may be varied depending on the speed. Therefore, in the modification 2, the case where when the speed of the vehicle 1 is greater than a predetermined speed, the correction route is used for correction, and when the speed is equal to or less than the predetermined speed (an example of the second speed), the correction route is not used for correction will be explained. In the present embodiment, the case where the predetermined speed is 0 km/h will be explained, but the predetermined speed is not limited to 0 km/h. For example, the predetermined speed may be any speed at which control can be performed to make the speed of the vehicle the given steering angle (for example, steering angle ‘0’) at which the vehicle is movable along the movement route even when as a given speed, the vehicle 1 is moving at the predetermined speed.

When the speed of the vehicle 1 is greater than the predetermined speed (for example, 0 km/h), the route correction unit 44b according to the present modification performs the same control as in the first embodiment, and thus the corresponding description will be omitted. On the other hand, the route correction unit 44b of the present modification does not correct the movement route when the speed of the vehicle 1 is equal to or less than the predetermined speed (0 km/h).

The steering angle controller 44c of the present modification controls the steering system 13 to make the steering angle of the vehicle 1 the given steering angle (steering angle ‘0’) at which the vehicle is movable according to the movement route when the speed of the vehicle 1 is equal to or less than a predetermined speed (0 km/h). In the present modification, after being controlled to the given steering angle (steering angle ‘0’), the steering angle controller 44c controls the steering system 13 such that the steering angle of the vehicle 1 is made a steering angle based on the movement route acquired by the route acquisition unit 44a, thereby implementing the movement of the vehicle 1 according to the movement route.

In the present modification, in a case where parking assistance is started when the speed of the vehicle 1 is greater than a predetermined speed, the control same as that of the above-described embodiment is performed. Thus, the effect same as that of the above-described embodiment is obtained. Further, the control is performed to make the steering angle of the vehicle the given steering angle (steering angle ‘0’) when the speed of the vehicle 1 is equal to or less than the predetermined speed, so that the correction by the correction route is unnecessary. Thereby, the processing burden for moving to the parking target position 52 can be reduced.

While the embodiments and the modifications of the present invention have been described, the embodiments and the modifications are presented as examples and are not intended to limit the scope of the invention. These novel embodiments can be implemented in various other forms, and various omissions, substitutions, and modifications can be made without departing from the scope of the invention. These embodiments and modifications thereof are included in the scope and the gist of the invention, and are included in the invention described in the claims and the equivalent scope thereof.

1. A parking assistance apparatus comprising:
a memory; and
a hardware processor coupled to the memory and configured to acquire a movement route from an initial position of a vehicle to a target position when a steering angle of the vehicle is a given steering angle, wherein
the memory is configured to store, with respect to individual steering angles other than the given steering angle, information representing a route where the vehicle is movable from the initial position of the vehicle to a position included in the movement route by performing steering angle control beginning at the corresponding steering angle,
the hardware processor is configured to acquire a steering angle of the vehicle, and
calculate, based on the acquired steering angle, a corrected movement
route from the initial position to the target position of the vehicle by correcting the movement route with a route where the vehicle is movable to a position included in the movement route at the acquired steering angle in accordance with information representing the route stored in the memory.

2. The parking assistance apparatus according to claim 1, wherein
the memory is further configured to store information that represents a plurality of circumferences functioning as part of the movement route of the vehicle,
the hardware processor
selects one of the plurality of circumferences stored in the memory, the selected one being a circumference that passes through the initial position and is tangential to a straight line extending in a traveling direction of the vehicle, and
acquires the movement route where the selected circumference functions as part of the movement route,
the memory stores, in association with each of the plurality of circumference, information representing a route where the vehicle is movable from the initial position of the vehicle to a position included in the movement route by performing steering angle control beginning at the corresponding steering angle, and
the hardware processor corrects the movement route with a route where the vehicle is movable to a position included in the movement route at the acquired steering angle in accordance with information representing the route stored in the memory, the route being associated with the circumference used for calculating the movement route.

3. The parking assistance apparatus according to claim 1, wherein, when the acquired steering angle is between a first steering angle and a second steering angle stored in the memory, the hardware processor corrects the movement route with a route where the vehicle is movable to a position included in the movement route at the acquired steering angle in accordance with information representing the route stored in the memory based on a steering angle having a larger absolute value between the first steering angle and the second steering angle.

4. The parking assistance apparatus according to claim 1, wherein, when a speed of the vehicle is within a first speed range, the hardware processor corrects, based on the acquired steering angle, the movement route with a route where the vehicle is movable to a position included in the movement route at the acquired steering angle in accordance with information representing the route stored in the memory.

5. The parking assistance apparatus according to claim 1, wherein
the hardware processor
does not perform the correction of the movement route when a speed of the vehicle is equal to or less than a second speed, and
performs, when the speed of the vehicle is equal to or less than the second speed, steering angle control based on the acquired movement route after performing control to make a steering angle of the vehicle the given steering angle.
